(19) United States
(12) Patent Application Publication
(10) Pub. No.: US 2014/0181097 A1
(43) Pub. Date: Jun. 26, 2014

(54) PROVIDING ORGANIZED CONTENT

(71) Applicant: MICROSOFT CORPORATION, Redmond, WA (US)

(72) Inventors: Sumit Basu, Seattle, WA (US); Lucretia Vanderwende, Sammamish, WA (US); Lanbo Zhang, Santa Cruz, CA (US)

(73) Assignee: MICROSOFT CORPORATION, Redmond, WA (US)

(21) Appl. No.: 13/721,064

(22) Filed: Dec. 20, 2012

(51) Int. Cl. G06F 17/30

(52) U.S. Cl. CPC G06F 17/3053
USPC 707/728; 707/758

(57) ABSTRACT

Systems and methods for providing organized content are described herein. In one example, a method includes identifying a spine document from a collection of documents, wherein the spine document comprises a plurality of sections. The method also includes splitting a related document into a plurality of subdocuments. In addition, the method includes mapping the subdocuments to corresponding sections of the spine document. Furthermore, the method includes displaying subdocuments based on a search of the collection of documents.

### BACKGROUND

As the amount of digital content continues to grow in various fields, users are confronted with an increasing number of documents to analyze while performing tasks such as web searches, legal discovery, and scientific literature research, among others. In order to review the large number of documents for relevant information, users may rely on various techniques that can sort the documents. However, a user can still spend a considerable amount of time reviewing the sorted documents for relevant information.

### SUMMARY

The following presents a simplified summary in order to provide a basic understanding of some aspects described herein. This summary is not an extensive overview of the claimed subject matter. This summary is not intended to identify key or critical elements of the claimed subject matter nor delineate the scope of the claimed subject matter. This summary's sole purpose is to present some concepts of the claimed subject matter in a simplified form as a prelude to the more detailed description that is presented later.

An embodiment provides a method for providing organized content. The method can include identifying a spine document from a collection of documents, wherein the spine document comprises a plurality of sections. The method can also include splitting a related document into a plurality of subdocuments. In addition, the method can include mapping the subdocuments to corresponding sections of the spine document. Furthermore, the method can include displaying subdocuments based on a search of the collection of documents.

Another embodiment is a system for providing organized content comprising a display device to display a subdocument, a processor to execute processor executable code, and a storage device that stores processor executable code. In some embodiments, the processor executable code, when executed by the processor, causes the processor to identify a spine document from a collection of documents, wherein the spine document comprises a plurality of sections. The processor executable code can also cause the processor to split a related document into a plurality of subdocuments and map the subdocuments to corresponding sections of the spine document. Furthermore, the processor executable code can cause the processor to display subdocuments based on a search of the collection of documents.

Another embodiment provides one or more tangible computer-readable storage media comprising a plurality of instructions. The instructions can cause a processor to identify a spine document from a collection of documents, wherein the spine document comprises a plurality of sections. The instructions can also cause a processor to split a related document from the collection of documents into a plurality of subdocuments and map the subdocuments to corresponding sections of the spine document. Furthermore, the instructions can cause the processor to display subdocuments based on a search of the collection of documents and a relationship of the subdocuments and the spine document, wherein the relationship between the subdocuments and the spine document comprises one of a complementary relationship, a redundant relationship, and a matched relationship.

### BRIEF DESCRIPTION OF THE DRAWINGS

The following detailed description may be better understood by referencing the accompanying drawings, which contain specific examples of numerous features of the disclosed subject matter.

FIG. 1 is a block diagram of an example of a computing system that provides organized content;

FIG. 2 is a process flow diagram of an example method for providing organized content;

FIG. 3 is an illustration of an example of displaying information from subdocuments related to a spine document;

FIG. 4 is an illustration of an example of displaying information about subdocuments that are relevant to a spine document; and

FIG. 5 is a block diagram illustrating an example of a tangible, computer-readable storage media that provides organized content.

### DETAILED DESCRIPTION

Several techniques for providing organized content have been developed, such as providing documents that are ranked based on a calculated relevance, providing documents that are ranked based on a personal relevance, providing documents identified with a clustered search, and providing documents organized with a faceted search, among others. However, these techniques do not assist a user in searching for content within a collection of documents based on the scope of each document. The scope of a document, as referred to herein, is an indication of the various topics included in the document and the amount of text included in each document for each of the various topics.

Various methods for providing organized content are described herein. Content, as referred to herein, can include documents and webpages, among others. In some embodiments, a spine document is identified from a collection of documents. A spine document, as referred to herein, is a document that can include any suitable number of sub-topics represented in a collection of documents. For example, a collection of documents may include a number of related documents, in which each related document includes a number of sub-topics related to a particular topic. In some embodiments, the spine document may be the document from the collection of documents that includes the largest number of sub-topics, or the longest document from the collection of documents, among others. In some embodiments, the related documents can be displayed based on a relationship with the spine document. For example, a related document may include a number of sub-topics discussed in the spine document. In some examples, a sub-topic in a related document may contain information that is included in the spine document (also referred to herein as redundant information), information that is neither a match nor a duplicate of information in a section of the spine document (also referred to herein as complementary information), or information matching the text of a section of the spine document.

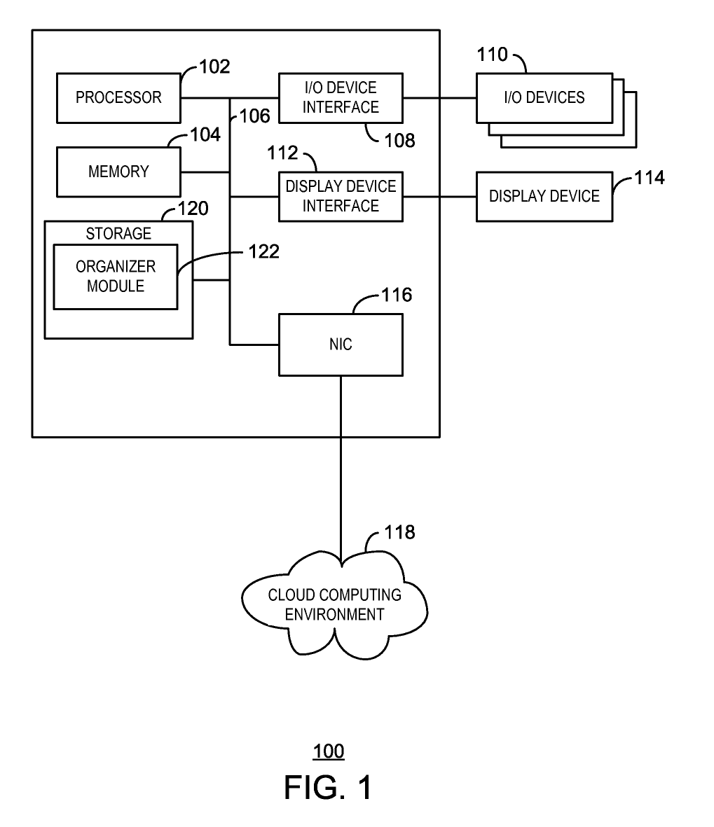

As a preliminary matter, some of the figures describe concepts in the context of one or more structural components, referred to as functionalities, modules, features, elements, etc. The various components shown in the figures can be implemented in any manner, for example, by software, hardware (e.g., discrete logic components, etc.), firmware, and so on, or any combination of these implementations. In one embodiment, the various components may reflect the use of corresponding components in an actual implementation. In other embodiments, any single component illustrated in the figures may be implemented by a number of actual components. The depiction of any two or more separate components in the figures may reflect different functions performed by a single actual component. FIG. 1, discussed below, provides details regarding one system that may be used to implement the functions shown in the figures.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into plural component blocks, and certain blocks can be performed in an order that differs from that which is illustrated herein, including a parallel manner of performing the blocks. The blocks shown in the flowcharts can be implemented by software, hardware, firmware, manual processing, and the like, or any combination of these implementations. As used herein, hardware may include computer systems, discrete logic components, such as application specific integrated circuits (ASICs), and the like, as well as any combinations thereof.

As for terminology, the phrase “configured to” encompasses any way that any kind of structural component can be constructed to perform an identified operation. The structural component can be configured to perform an operation using software, hardware, firmware and the like, or any combinations thereof.

The term “logic” encompasses any functionality for performing a task. For instance, each operation illustrated in the flowcharts corresponds to logic for performing that operation. An operation can be performed using software, hardware, firmware, etc., or any combinations thereof.

As utilized herein, terms “component,” “system,” “client” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any tangible, computer-readable device, or media.

Computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media generally (i.e., not storage media) may additionally include communication media such as transmission media for wireless signals and the like.

FIG. 1 is a block diagram of an example of a computing system that provides organized content. The computing system 100 may be, for example, a mobile phone, laptop computer, desktop computer, or tablet computer, among others. The computing system 100 may include a processor 102 that is adapted to execute stored instructions, as well as a memory device 104 that stores instructions that are executable by the processor 102. The processor 102 can be a single core processor, a multi-core processor, a computing cluster, or any number of other configurations. The memory device 104 can include random access memory (e.g., SRAM, DRAM, zero capacitor RAM, SONOS, eDRAM, EDO RAM, DDR RAM, RRAM, PRAM, etc.), read only memory (e.g., Mask ROM, PROM, EPROM, EEPROM, etc.), flash memory, or any other suitable memory systems. The instructions that are executed by the processor 102 may be used to provide organized content.

The processor 102 may be connected through a system bus 106 (e.g., PCI, ISA, PCI-Express, HyperTransport®, NuBus, etc.) to an input/output (I/O) device interface 108 adapted to connect the computing system 100 to one or more I/O devices 110. The I/O devices 110 may include, for example, a keyboard, a gesture recognition input device, a voice recognition device, and a pointing device, wherein the pointing device may include a touchpad or a touchscreen, among others. The I/O devices 110 may be built-in components of the computing system 100, or may be devices that are externally connected to the computing system 100.

The processor 102 may also be linked through the system bus 106 to a display device interface 112 adapted to connect the computing system 100 to a display device 114. The display device 114 may include a display screen that is a built-in component of the computing system 100. The display device 114 may also include a computer monitor, television, or projector, among others, that is externally connected to the computing system 100. A network interface card (NIC) 116 may also be adapted to connect the computing system 100 through the system bus 106 to a cloud computing environment (also referred to herein as a service over network computing environment) 118. The cloud computing environment 118 can include any suitable number of servers, databases, and other infrastructure that can provide organized content in accordance with the embodiments described herein.

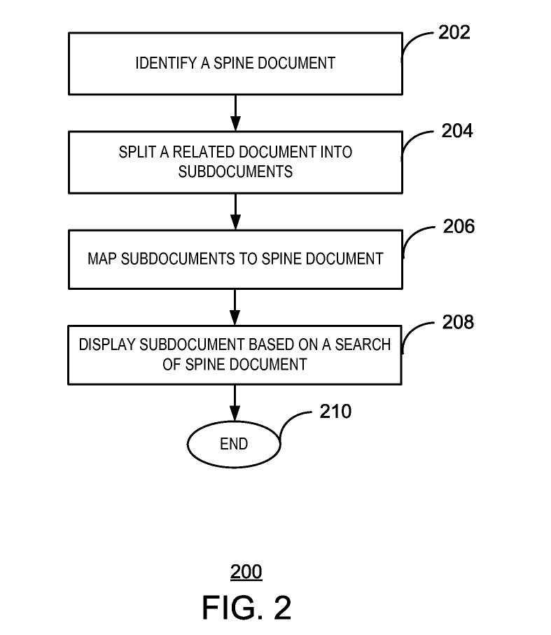

The storage 120 can include a hard drive, an optical drive, a USB flash drive, an array of drives, or any combinations thereof. The storage 120 may include an organizer module 122. The organizer module 122 can identify a spine document, identify subdocuments within a related document, and determine the relationship between each subdocument and the spine document. In some examples, the relationship between each subdocument and the spine document can include redundant subdocuments, duplicate subdocuments, complementary subdocuments, and matching subdocuments, among others. In some embodiments, the spine document can be identified from a collection of related documents. The remaining documents in the collection can be referred to as related documents. Each of the related documents can include any suitable number of subdocuments, which can be identified based on sections or paragraphs, among others. A subdocument, as referred to herein, includes any suitable portion of text, or other content within a document. The organizer module 122 can determine a relevance score for each subdocument in relation to the spine document. The relevance score, as referred to herein, can include the probability that the information of a subdocument matches the sub-topic of a section of a spine document. For example, the organizer module 122 can use any suitable data structure, such as vectors or arrays, among others, to store information related to each subdocument. In some embodiments, vectors can be used to store the number of occurrences of each word in a subdocument. Calculating a relevance score is discussed in greater detail below in relation to FIG. 2.

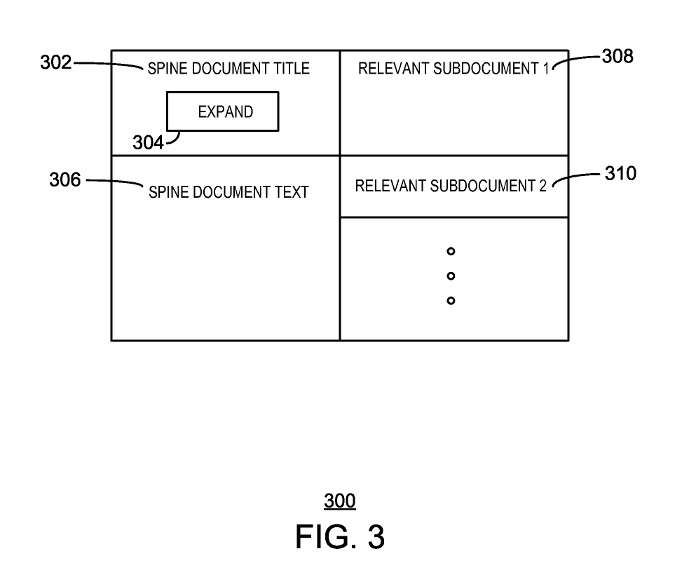

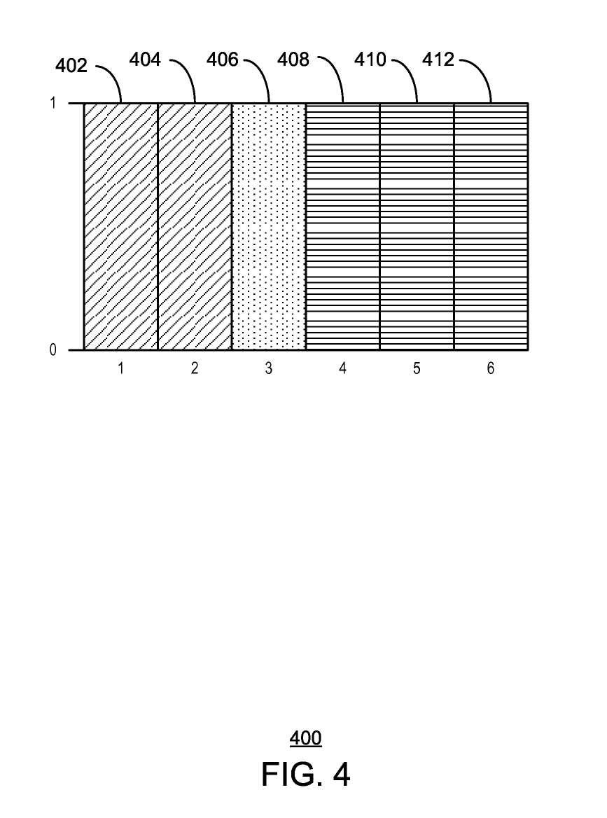

In some embodiments, the organizer module 122 can also display the relationships between the subdocuments and a spine document. In some examples, the organizer module 122 can provide a highlighted related document in which the relationship between each subdocument and the spine document is presented with a different shading or color. In one example, a chart may be provided that indicates the relationship between each subdocument and a spine document. The various techniques for displaying the relationships between subdocuments and a spine document are discussed in greater detail below in relation to FIGS. 3 and 4.

It is to be understood that the block diagram of FIG. 1 is not intended to indicate that the computing system 100 is to include all of the components shown in FIG. 1. Rather, the computing system 100 can include fewer or additional components not illustrated in FIG. 1 (e.g., additional applications, additional modules, additional memory devices, additional network interfaces, etc.). Furthermore, any of the functionalities of the organizer module 122 may be partially, or entirely, implemented in hardware and/or in the processor 102. For example, the functionality may be implemented with an application specific integrated circuit, in logic implemented in the processor 102, in a processor in the cloud computing environment 118, or in any other device.

FIG. 2 is a process flow diagram of an example method for providing organized content. The method 200 can be implemented with a computing system, such as the computing system 100 of FIG. 1.

At block 202, the organizer module 122 identifies a spine document from a collection of documents, wherein the spine document comprises a plurality of sections. In some embodiments, each section of the spine document may be related to a particular sub-topic. For example, each section of the spine document may include text related to a particular aspect of the general topic of the spine document. In some embodiments, the spine document is identified as an authoritative document on a subject, such as a WIKIPEDIA® page, among others, as the document that contains the most subdocuments, or the document that contains at least one subdocument from the most number of documents. In one embodiment, the spine document is identified by selecting a document that has the highest relevance to a search query, selecting a document with the highest number of words, selecting an authoritative document, such as a WIKIPEDIA® page, or selecting the document with the highest search rank, among others. For example, the topic of the spine document may be identified from a search query such as a legal query or a medical query, among others.

At block 204, the organizer module 122 splits a document into a plurality of subdocuments. In some embodiments, the subdocuments can relate to sub-topics that may be related to the topic of the spine document. For example, the sub-topics may relate to a chronological history of the topic of the spine document, or any other subject matter related to the topic of the spine document. In some embodiments, the subdocuments can be split from the related documents using any suitable granularity. For example, a document may have section headings that identify subdocuments. In some embodiments, any suitable type of formatting can be used to split a related document into subdocuments. For example, paragraph formatting, section formatting, subsection formatting, or sentence formatting, among others can be used to split a document into subdocuments.

At block 206, the organizer module 122 maps the subdocuments to corresponding sections of the spine document. In some embodiments, the subdocuments are mapped to sections of the spine document based on a relevance score for each subdocument. In some examples, the relevance score can be based on a set of calculations. For example, the relevance score can be based on the cosine of a vector representation of the words in the section of the spine document and a vector representation of the words of the subdocument text. In some embodiments, each entry of a vector can correspond to a word in the subdocument or the spine document. The relevance score can also be based on the cosine of a vector representation of the words in the section title of the spine document and a vector representation of the words in the title of the subdocument. In some embodiments, the relevance score can also be based on a cosine of the vector representation of the nouns in a section of the spine document and a vector representation of the nouns in a corresponding subdocument. In some examples, the vector representation can be based on TFIDF algorithms. In one embodiment, the relevance score can also be based on a similarity determined by BM25 algorithms. A term frequency-inverse document frequency (also referred to herein as TFIDF) vector representation can store the number of occurrences of each word from a section or title of text. In some embodiments, techniques are used to account for common words such as “a” and “an”, among others. For example, the number of occurrences of a word in a subdocument may be divided by the number of documents in a collection to normalize the TFIDF vector representation of a subdocument. An Okapi BM25 algorithm (also referred to herein as BM25) can rank subdocuments according to the relevance of a subdocument regarding a particular query, where the query can be arbitrarily long, for example, the words from a particular section of the spine document. For example, the BM25 relevance score can indicate the relevance of a subdocument based on the number of occurrences of the words from such a search query within the subdocument.

In some embodiments, the relevance score can be based on a BM25 similarity score or a cosine of two TFIDF vectors. The cosine similarity of two vectors can be calculated based on an inner product of the two vectors. In one embodiment, the cosine of two vectors can indicate the similarity of a subdocument and a section of a spine document. In some examples, the cosine similarity can be normalized. For example, the organizer module 122 may map the lowest cosine similarity value to a zero value and map the highest cosine similarity value to a one value. In some embodiments, both the cosine similarity value and the normalized value can be stored. In some examples, the organizer module 122 can also consider additional information when normalizing the cosine similarity value if the range of the cosine similarity values is small. In some embodiments, any suitable combination of TFIDF-based and BM25-based similarity scores and other appropriate features, such as subdocument length, can be used to determine a relevance score. For example, a similarity between a subdocument and a spine document can be calculated using any suitable technique or combination of techniques such as logistic regression, linear regression, decision tress, neural networks, and support vector machines, among others. The relevance score, as referred to herein, can include the probability that the information of a subdocument matches the sub-topic of a section of a spine document.

In some embodiments, the relevance scores and other metrics, such as subdocument length and domain reliability of a spine document, among others, are input into a classifier that can output a probability that a subdocument matches a section of a spine document. In some embodiments, the classifier can use logistic regression, linear regression, decision tress, neural networks, and support vector machines, among others to produce the output of the probability that a subdocument matches a section of the spine document. In some examples, the relevance scores and other metrics can train the classifier by comparing the output of the classifier to predetermined results. For example, the output of the classifier can be compared to results from crowd sourced tasks in which judges decide whether a subdocument matches a section of a spine document, among others.

At block 208, the organizer module 122 displays subdocuments based on a search of the collection of documents. In some embodiments, the organizer module 122 can search a collection of documents for subdocuments with a relevance score above a threshold for a section of the spine document. In some embodiments, a document can be highlighted based on the relationship of text in the document to the spine document. As discussed above, a relationship between a related document and a spine document can indicate redundant information, complementary information, and matching information. In some examples, each relationship can be indicated with a different shade or color of highlighting to depict the relationship between text in a document and the spine document. For example, redundant information in a subdocument that is also discussed in the spine document may appear shaded or highlighted. Displaying relationships between subdocuments and the spine document are discussed below in greater detail in relation to FIGS. 3 and 4.

In some embodiments, a chart can also display the relationship of each section of a document to a spine document. For example, a chart can indicate if the document contains redundant information, complementary information, or matching information, among others. At block 210, the process flow ends.

The process flow diagram of FIG. 2 is not intended to indicate that the steps of the method 200 are to be executed in any particular order, or that all of the steps of the method 200 are to be included in every case. For example, a document can be split into subdocuments before a spine document is identified. Furthermore, the method 200 can be repeated in any suitable number of iterations. For example, after identifying a spine document and identifying relationships between subdocuments and the spine documents, the organizer module 122 may detect a set of read documents or subdocuments. The organizer module 122 can detect a set of read documents based on a user's history of viewed documents in various applications such as web browsers, electronic readers, and word processing programs, among others. In some embodiments, the organizer module 122 can update the spine document based on the set of read documents. For example, the organizer module 122 can remove the set of read documents from a collection of related documents. In some embodiments, the organizer module 122 can also use an additional relationship indicator to indicate that a subdocument belongs to a set of read documents. In some examples, the organizer module 122 can recalculate relationships between the spine document, including previously read documents, and subdocuments that have not been viewed. For example, a display of the spine document and the related documents can be updated to indicate the relationship between unviewed subdocuments and the spine document as well as the set of read documents.

FIG. 3 is an illustration of an example of displaying information from subdocuments related to a spine document. The display 300 includes a spine document title 302, an expand button 304, and spine document text 306. The spine document title 302 indicates the topic of the spine document and the spine document text 306 includes the various sections of the spine document. In some embodiments, the expand button 304 can enable any suitable number of relevant subdocuments 308 and 310 to be displayed. For example, a user may wish to view subdocuments that are related to a particular section of the spine document. In some examples, the expand button 304 can enable the display of the relevant subdocuments 308 and 310 that are related to a section of the spine document.

In some embodiments, the organizer module 122 can determine that a subdocument 308 or 310 is relevant to the topic of the spine document and that the subdocument 308 or 310 matches a section of the spine document. The organizer module 122 can also provide the text from the subdocuments 308 and 310, also referred to herein as matched subdocuments, that correspond to a particular section of the spine document. A matched subdocument can be identified with various machine learning techniques, such as neural networks, among others. The machine learning techniques can determine if a matched subdocument augments a section of the spine document. In some examples, augmenting a section of the spine document can include determining whether the information in the section of the spine document is a subset of the subdocument, or if the information in the subdocument augments the information in the section of the spine document.

In some embodiments, a matched subdocument can be identified using the relevance scores computed for each subdocument. In some embodiments, a relevance score over a suitable number or percent can indicate a subdocument is a match to a section of the spine document. In some examples, a user can adjust the value of the relevance score that indicates a subdocument is a match to a section of the spine document.

The illustration of FIG. 3 is not intended to indicate that the organizer module 122 is to display all of the features of FIG. 3. Rather, the organizer module 122 can display any suitable number of relevant subdocuments, among others. Furthermore, the organizer module 122 may not display an expand button 304. For example, the organizer module 122 may automatically provide documents related to a section that is currently being viewed.

FIG. 4 is an illustration of an example of displaying the relationship of subdocuments to a spine document. In some embodiments, the relationships can include a matched relationship, a complementary relationship, or a redundant relationship, among others. The organizer module 122 can provide a chart 400 to be displayed that indicates the relationship between each subdocument in a related document and the spine document. For example, the chart may use a different shading or color to indicate the relationship for each subdocument. In some embodiments, the chart 400 can display a particular document, in which the various subdocuments contained in the document are displayed based on the relationship between the subdocument and the spine document.

The chart 400 displays six subdocuments of a related document. In some embodiments, the left axis of chart 400 includes values between zero and one, which indicate the probability that a subdocument has a particular relationship with the spine document. In the example illustrated in chart 400, each subdocument has a one-hundred percent probability that each subdocument has a particular relationship with a section of the spine document. The shading of chart 400 indicates the relationship between each subdocument and a spine document. For example, the slanted lines through subdocument 1 402 and subdocument 2 404 of chart 400 may indicate that subdocument 1 and subdocument 2 match sections of a spine document. In this example, subdocuments 1 and 2 may include relevant information to a section of the spine document because the matching relationship indicates a high relevance score. In some examples, the subdocument 3 406 of chart 400 includes a dotted shading that may indicate that subdocument 3 includes complementary information to a spine document. For example, subdocument 3 may include information that does not match information in a section of the spine document and is not redundant information in relation to a section of the spine document. In some examples, the horizontal-line shading in subdocument 4 408, subdocument 5 410, and subdocument 6 412 of chart 400 may indicate that subdocuments 4, 5, and 6 include redundant information that is already included in a spine document. In some embodiments, a redundant relationship can be calculated based on whether a subdocument contains a superset of subset of concepts from a section of the spine document. In some examples, a redundant relationship can also be determined based on the amount of overlap in concepts between the subdocument and the section of the spine document or the length of the subdocument, or other features of the subdocument.

Some subdocuments may also be near-verbatim duplicates of sections of the spine document. In some embodiments, the organizer module 122 can detect duplicate subdocuments by calculating a TFIDF based cosine similarity between each sentence of a subdocument and each sentence of a section of the spine article. In some examples, the maximum cosine similarity value for each sentence in the subdocument to some sentence in the spine document can be stored in any suitable data structure such as a vector, among others. The organizer module 122 can calculate the mean of the stored maximum cosine similarity values and determine if the mean value is above a threshold. If the mean value is above a threshold, the sentence of a subdocument can be considered a duplicate to a sentence in the spine document. In some embodiments, the threshold value for determining a duplicate can be predetermined, or periodically modified.

The illustration of FIG. 4 is not intended to indicate that the organizer module 122 is to display all of the features of FIG. 4. Rather, the organizer module 122 can display any suitable number of documents and subdocuments, among others. Furthermore, the organizer module 122 can display the relationship of a subdocument in relation to a section of the spine document with colors, shading, or images, among others.

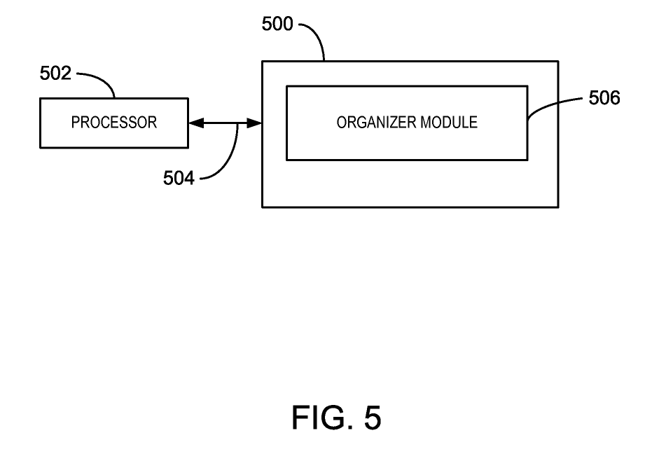

FIG. 5 is a block diagram showing a tangible, computer-readable storage media 500 that provides organized content. The tangible, computer-readable storage media 500 may be accessed by a processor 502 over a computer bus 504. Furthermore, the tangible, computer-readable storage media 500 may include code to direct the processor 502 to perform the steps of the current method.

The various software components discussed herein may be stored on the tangible, computer-readable storage media 500, as indicated in FIG. 5. For example, the tangible computer-readable storage media 500 can include an organizer module 506. The organizer module 506 can organize content based on a topic by identifying a spine document and identifying relationships for subdocuments within documents related to the spine document. The organizer module 506 can also display the relationship between a subdocument and the spine document through charts and highlighting techniques, among others.

It is to be understood that any number of additional software components not shown in FIG. 5 may be included within the tangible, computer-readable storage media 500, depending on the specific application. Although the subject matter has been described in language specific to structural features and/or methods, it is to be understood that the subject matter defined in the appended claims is not necessarily limited to the specific structural features or methods described above. Rather, the specific structural features and methods described above are disclosed as example forms of implementing the claims.

What is claimed is:

1. A method for providing organized content comprising:
identifying a spine document from a collection of documents, wherein the spine document comprises a plurality of sections;
splitting a related document into a plurality of subdocuments;
mapping the subdocuments to corresponding sections of the spine document; and
displaying subdocuments based on a search of the collection of documents.

2. The method of claim 1 comprising highlighting the subdocuments based on the relationship between the subdocuments and the corresponding sections of the spine document.

3. The method of claim 2, wherein the relationship between the subdocuments and the sections of the spine document comprises a complementary relationship, a redundant relationship, a duplicate relationship, and a matching relationship.

4. The method of claim 1, wherein displaying subdocuments comprises:
determining a relationship between the subdocuments and the spine document; and
displaying the subdocuments based on the relationship.

5. The method of claim 1, wherein choosing the spine document comprises one of selecting a document from the collection of documents that has a highest relevance to the search, selecting a document from the collection of documents with a highest search rank, and selecting a document from the collection of documents with the largest number of words.

6. The method of claim 1, wherein splitting the document into a plurality of subdocuments comprises splitting the document based on one of a paragraph format, a section format, and a subsection format.

7. The method of claim 1 comprising calculating a relevance score of each of the subdocuments, wherein the relevance score is calculated with a logistic regression technique.

8. The method of claim 7, wherein calculating a relevance score of the subdocument comprises:
generating a first vector representation of the words in a subdocument, wherein each entry in the first vector corresponds to a specific word in the subdocument;
generating a second vector representation of the words of the section of text in the spine document, wherein each entry in the second vector corresponds to a specific word in the spine document; and
detecting a cosine similarity between the first vector and the second vector.

9. The method of claim 7, wherein calculating a relevance score of the subdocument comprises:
generating a first vector representation of the words in the subdocument, wherein each entry in the first vector corresponds to a specific word in the subdocument;
generating a second vector representation of the words of the title of the section of text in the spine document, wherein each entry in the second vector corresponds to a specific word in the title of the spine document; and
detecting a cosine similarity between the first vector and the second vector.

10. The method of claim 7, wherein calculating a relevance score of the subdocument comprises:
generating a first vector representation of the nouns in a subdocument, wherein each entry in the first vector corresponds to a specific noun in the subdocument;
generating a second vector representation of the nouns of a section of text in the spine document, wherein each entry in the second vector corresponds to a specific noun in the section of the spine document; and
detecting a cosine similarity between the first vector and the second vector.

11. The method of claim 7, wherein calculating a relevance score of the subdocument comprises generating a similarity between words of a section of the spine document and words of the subdocument using an Okapi BM25 technique.

12. The method of claim 7, wherein calculating a relevance score of the subdocument comprises generating a cosine similarity between words of a title of a section of the spine document and words of a title of the subdocument using a term frequency-inverse document frequency technique.

13. The method of claim 1 comprising:
detecting a set of read documents from a collection of documents; and
augmenting the spine document based on the set of read documents to produce an augmented spine document; and
calculating a relationship between a subdocument and the augmented spine document.

14. One or more computer-readable storage media comprising a plurality of instructions that, when executed by a processor, cause the processor to:
identify a spine document from a collection of documents, wherein the spine document comprises a plurality of sections;
split a related document from the collection of documents into a plurality of subdocuments;
map the subdocuments to corresponding sections of the spine document; and
display subdocuments based on a search of the collection of documents and a relationship of the subdocuments to the spine document, wherein the relationship between the subdocuments to the spine document comprises one of a complementary relationship, a redundant relationship, a duplicate relationship, and a matching relationship.

15. The one or more computer-readable storage media of claim 14, wherein the plurality of instructions, when executed by the processor, cause the processor to:
generate a chart based on the relationship between the subdocuments and the spine document; and
display the relationship between the subdocuments and the spine document.

16. The one or more computer-readable storage media of claim 14, wherein the plurality of instructions, when executed by the processor, cause the processor to highlight the subdocuments based on the relationship between the subdocuments and the corresponding sections of the spine document.

17. A system for providing organized content comprising:
a display device to display a plurality of subdocuments;
a processor to execute processor executable code;
a storage device that stores processor executable code, wherein the processor executable code, when executed by the processor, causes the processor to:
identify a spine document from a collection of documents, wherein the spine document comprises a plurality of sections;
split a related document into the plurality of subdocuments;
map the subdocuments to corresponding sections of the spine document; and
display subdocuments based on a search of the collection of documents.

18. The system of claim 17, wherein the processor resides in a service over network computing environment.

19. The system of claim 18, wherein the relationship between the subdocuments and the sections of the spine document comprises one of a complementary relationship, a redundant relationship, a duplicate relationship, and a matching relationship.

20. The system of claim 19, wherein the processor executable code, when executed by the processor, causes the processor to:
generate a chart based on a relationship between the subdocuments and the spine document; and
display the relationship between the subdocuments and the spine document.
